(19) United States
(12) Patent Application Publication
(10) Pub. No.: US 2024/0120533 A1
(43) Pub. Date: Apr. 11, 2024

(54) SEMI-INTERPENETRATING POLYMER NETWORKS AS SEPARATORS FOR USE IN ALKALI METAL BATTERIES

(71) Applicant: FORSCHUNGSZENTRUM JÜLICH GMBH, Jülich (DE)

(72) Inventors: Gerrit HOMANN, Münster (DE); Johannes KASNATSCHEEW, Dülmen (DE); Jijeesh Ravi NAIR, Münster (DE); Martin WINTER, Münster (DE)

(21) Appl. No.: 17/769,074

(22) PCT Filed: Oct. 12, 2020
(86) PCT No.: PCT/EP2020/078606

§ 371 Date: Apr. 14, 2022

(30) Foreign Application Priority Data
Oct. 14, 2019 (DE) 10 2019 127 616.0

(51) Int. Cl. H01M 10/0565; H01M 10/052

(52) U.S. Cl. CPC H01M 10/0565; H01M 10/052; H01M 2300/0082

(57) ABSTRACT

A solvent-free solid electrolyte is provided for an alkali metal solid state battery including an alkali metal conducting salt and a semi-interpenetrating network (sIPN) of a crosslinked and a non-crosslinked polymer. The semi-interpenetrating network is selected from a non-crosslinked polymer selected from the group consisting of polyethylene oxide (PEO), polycarbonate (PC), polycaprolactone (PCL), chain end modified derivatives of these polymers or mixtures of at least two components thereof, and the crosslinked polymer comprises polyethylene glycol dimethacrylate (PEGdMA). Furthermore, to a process is provided for preparing a solid electrolyte and to an alkali metal battery including the solid electrolyte.

### INTRODUCTION

The present disclosure relates to a solvent-free solid electrolyte for an alkali metal solid state battery comprising an alkali metal conducting salt and a semi-interpenetrating network (sIPN) of a crosslinked and a non-crosslinked polymer, wherein the semi-interpenetrating network is selected from a non-crosslinked polymer selected from the group consisting of polyethylene oxide (PEO), polycarbonate (PC), polycaprolactone (PCL), chain end modified derivatives of these polymers or mixtures of at least two components thereof, and the crosslinked polymer comprises polyethylene glycol dimethacrylate (PEGdMA). Furthermore, the disclosure relates to a process for preparing a solid electrolyte and to an alkali metal battery comprising the solid electrolyte.

Increased user demands for sustainability and mobility have significantly changed the landscape of decentralized energy storage in recent decades. Whereas in the past the possibilities for the technical use of batteries were significantly limited due to their size, weight and only very limited electrical capacity, since the use of alkali metal-based energy storage systems, for example in the form of rechargeable lithium batteries, the possible applications have increased significantly. Since their market launch in the early 1990s, lithium-ion batteries have made mobile applications such as smartphones and laptops suitable for mass use. Continuous further developments have also led to an increase in energy densities and application reliability. It is precisely these optimization steps that have contributed to the fact that lithium-ion batteries, for example, are nowadays considered as stationary energy storage devices for decentrally generated electricity in the private and industrial sectors. Furthermore, these innovative electrical storage systems form the basis of new, climate-friendly transport concepts in the field of electromobility.

In the field of alkali metal batteries, various technical concepts are being pursued to improve ease of use and storage capacity. One way of optimizing the safety and energy density of Li-metal batteries, for example, is to use solid electrolytes. Since polymer electrolytes have a lower gravimetric density compared with oxide- and sulfide-based solid electrolytes, this battery form offers in principle the possibility of achieving an increase in weight-related energy and power density relatively easily. In addition, polymer-based designs can demonstrate easier processability and better wetting of sulfide- or oxide-based composite electrodes. The basic requirement here is that the polymer electrolytes are compatible with respect to both the alkali metal and the positive electrode material, show homogeneous wetting of both electrodes, and allow deposition of alkali metal on the negative electrode.

The patent literature also provides some examples of the design of alkali metal batteries with polymer-based solid electrolytes.

For example, WO 2014 147648 A1 discloses a high ionic conductivity electrolyte composition. In particular, the document discloses high ionic conductivity electrolyte compositions of semi-interpenetrating polymer networks and their nanocomposites as a quasi-solid/solid electrolyte matrix for power generation, storage and delivery devices, in particular for hybrid solar cells, accumulators, capacitors, electrochemical systems and flexible devices. The binary or ternary component of a semi-interpenetrating polymer network electrolyte composition comprises: (a) a polymer network with polyether backbone (component I); (b) a linear, branched, hyperbranched polymer with low molecular weight or any binary combination of such polymers with preferably non-reactive end groups (component II and/or component III to form a ternary semi-IPN system); (c) an electrolyte salt and/or a redox couple; and optionally (d) a pure or surface-modified nanostructured material to form a nanocomposite.

WO 2015 043 564 A1 discloses a method of manufacturing at least one electrochemical cell of a solid-state battery comprising a mixed-conducting anode, a mixed-conducting cathode, and an electrolyte layer disposed between the anode and the cathode, comprising the steps,
a mixed conducting anode is produced or provided,
a mixed conducting cathode is produced or provided,
the surface of at least one of the two electrodes is modified by an additional process step in such a way that the electronic conductivity perpendicular to the cell is lowered to less than 108 S/cm in a layer of the electrode near the surface, and—subsequently, the anode and the cathode are assembled to form a solid-state battery in such a way that the surface-modified layer of at least one electrode is arranged at the boundary between the anode and the cathode as an electrolyte layer, and the mixed-conducting electrodes are thereby electronically separated.

Such solutions, known from the prior art, can offer further potential for improvement, particularly with regard to improved reproducibility of charging and discharging processes and especially in the low-temperature behavior of secondary batteries.

### SUMMARY

It is a task according to an embodiment to at least partially overcome the disadvantages known from the prior art. In particular, a task per an embodiment is to provide a solution by which improved charge and discharge stability as well as improved conductivity at low temperatures is provided even after repeated cycles.

Preferred embodiments are indicated in the dependent claims, in the description or in the figures, whereby further features described or shown in the subclaims or in the description or in the figures may individually or in any combination constitute an object per an embodiment of the invention, as long as the context does not clearly indicate the contrary.

According to an embodiment, a solid electrolyte for an alkali metal solid state battery is proposed, said solid electrolyte comprising at least an alkali metal conducting salt and a semi-interpenetrating network (sIPN) of a cross-linked and a non-cross-linked polymer, said semi-interpenetrating network comprising greater than or equal to 50% by weight and less than or equal to 80% by weight of a non-crosslinked polymer selected from the group consisting of polyethylene oxide (PEO), polycarbonate (PC), polycaprolactone (PCL), chain end modified derivatives of these polymers or mixtures of at least two components thereof; and greater than or equal to 20% by weight and less than or equal to 50% by weight of polyethylene glycol dimethacrylate (PEGdMA) as crosslinked polymer, wherein the solid electrolyte consists of greater than or equal to 90% by weight and less than or equal to 100% by weight of the alkali conducting salt and the sIPN, and the solid electrolyte is solvent-free. Surprisingly, solvent-free solid electrolytes with sIPN structure and above composition were found to have unexpectedly good electrical and mechanical properties. Batteries with these solid electrolytes show particularly stable charge and discharge characteristics, which suggests that alkali metal insertion and removal during cycling is achieved without severe damage to the polymer network. Furthermore, it appears that dendrite growth in particular can be reduced, resulting in consistent electrical properties even over repeated cycling. This can contribute to a particularly stable behavior of alkali metal batteries and, overall, to an increase in battery life with simultaneously increased electrical performance. Another advantage, per an embodiment, is that the electrical performance of alkali metal batteries can be reproducibly provided even at very low temperatures. The thermal operating window of alkali metal batteries is thus extended and, in particular, shifted toward lower temperatures, which can increase ease of use. Another advantage, per an embodiment, of these solid electrolytes is that higher voltages and currents can also be handled safely via the solid electrolyte, so that safe operation of alkali metal batteries can be ensured even under these more difficult electrical conditions. Without being bound by theory, it is believed that the polymer electrolyte, per an embodiment, has both a highly amorphous alkali ion conductive phase and increased mechanical stability. Both factors lead to higher operational reliability, more reproducible charge/discharge behavior, and a wider temperature application window.

The solid electrolyte, per an embodiment, is a solvent-free solid electrolyte for an alkali metal solid state battery. A solid electrolyte is also called a solid-state electrolyte, solid body electrolyte or solid ionic conductor. The solid electrolyte has a coherent polymeric support structure and alkali metal ions embedded therein, which are mobile within the polymeric matrix of the solid electrolyte. An electric current can flow via the mobility of the ions in the solid electrolyte. Solid electrolytes are electrically conductive, but show rather low electronic conductivity compared to metals. An alkali metal solid battery has at least two electrodes and a solid, in particular non-flowing electrolyte arranged between the electrodes. In addition to these components, a solid-state battery may have other layers or sheets. For example, a solid-state battery may have other layers between the solid electrolyte and the electrodes. The electrical properties of alkali metal solid state batteries are based on the redox reaction of alkali metals, i.e., the metals from the 1st main group of the periodic table. In particular, lithium, sodium and potassium can be used as alkali metals.

The solid electrolyte comprises at least one alkali metal conducting salt and a semi-interpenetrating network (sIPN) of a crosslinked and a non-crosslinked polymer. The mechanical backbone of the solid electrolyte is formed by a network of two different polymers and also obtains its strength from them. A semi-interpenetrating network is one that comprises two different polymer species. One polymer can be crosslinked to form a three-dimensional network by forming covalent bonds between the monomers, whereas the other polymer, in the absence of functional groups, is linked purely by ionic or van der Waals interactions. Both polymer components can, at least in principle, be separated from each other by a washout process. Due to the fact that crosslinking of the crosslinkable polymer by functional groups occurs only after a physical mixing process with the non-crosslinkable polymer, both components physically interpenetrate and together form the semi-interpenetrating network. The other component of the solid electrolyte is the alkali metal conducting salt, which is “dissolved” within the network or bound to it, but which, according to an embodiment, is not regarded as a component of the polymeric network but as a component of the solid electrolyte.

The semi-interpenetrating network comprises greater than or equal to 50% by weight and less than or equal to 80% by weight of a non-crosslinked polymer selected from the group consisting of polyethylene oxide (PEO), polycarbonate (PC), polycaprolactone (PCL), chain end modified derivatives of these polymers or mixtures of at least two components thereof. Thus, the semi-interpenetrating network constructed from two polymeric components has PEO, PC, PCL or mixtures of these components as the main weight component. The non-crosslinkable polymers may each be substituted at the chain ends.

PEO refers to monomers with the following structural formula

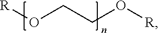

where the index n can suitably be selected from 10 to 120000. The radicals R may each independently of one another be hydrogen or a substituted or unsubstituted alkyl or aryl radical. The substituted or unsubstituted alkyl or aryl radicals may have a C-number from C1 to C20 and may have further, non-crosslinkable functional substituents, such as halogen, NH3, NO2.

Polycarbonates are compounds with the following structural formula

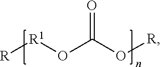

where the index n can be suitably selected from 3 to 120000. The radicals R at the chain ends correspond to the above definition. The group R1 stands for an aromatic or aliphatic C1-C15 group.

Polycaprolactone refers to compounds with the following structural formula

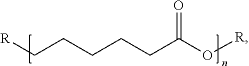

where the index n can be suitably selected from 3 to 120000. The residues R at the chain ends correspond to the above definition.

In addition to the non-crosslinkable polymer, the semi-interpenetrating network contains greater than or equal to 20% by weight and less than or equal to 50% by weight polyethylene glycol dimethacrylate (PEGdMA) as the crosslinked polymer. The weight data here refer to the two polymeric components and in this respect the proportion by weight of the PEGdMA in the polymeric network is at most equal to the proportion of the non-crosslinkable component. When calculating the weight fractions, the weight fractions of the alkali metal conducting salt are not taken into account, since the formation of the semi-interpenetrating network is essentially determined by the polymeric components. PEGdMA is understood to be a monomer with the following structure

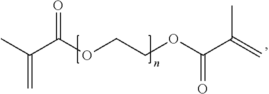

where the index n can suitably assume values from 5 up to 1000. The monomer has two methacrylic functional groups which are responsible for the crosslinking of different monomers.

The weight fractions of the crosslinked and the uncrosslinked polymer in the sIPN can add up to 100 wt.-%. According to an embodiment, it is possible for the semi-interpenetrating network to have no other monomer/polymer constituents in larger amounts in addition to the polymer constituents mentioned. Larger amounts are, for example, amounts above 5% by weight based on the crosslinked and non-crosslinked polymers mentioned above. In an embodiment, no further monomers or polymers may be present in the structure of the solid electrolyte in addition to the alkali metal conducting salt and the specified crosslinked and non-crosslinked polymers.

According to an embodiment, the solid electrolyte consists of greater than or equal to 90% by weight and less than or equal to 100% by weight of the alkali conducting salt and the sIPN. To obtain the most uniform and reproducible charge/discharge characteristics possible for a battery comprising the solid electrolyte according to an embodiment, it has proved particularly advantageous for the solid electrolyte not to comprise any constituents other than the cross-linked polymer, un-crosslinked polymer and conducting salt. In particular, the solid electrolyte can be solvent-free. Furthermore, the solid electrolyte may be free of further constituents which are intended to increase the solubility of the alkali metal conducting salt or to impart further mechanical stability to the semi-interpenetrating network. This design can help in particular to maintain the amorphous structure of the semi-interpenetrating network, which can also contribute to the most consistent conductivity possible even at low temperatures.

In another embodiment of the solid electrolyte, the non-crosslinked polymer may be polyethylene oxide and the solid electrolyte may have a molar ratio of ethylene oxide units to alkali ions, expressed by the quotient EO/Li, of greater than or equal to 5 and less than or equal to 15. To obtain the highest possible conductivity, even at relatively low temperatures, the above ratio of ethylene oxide units to alkali ions in the solid electrolyte has proved to be particularly suitable. This ratio allows relatively high mobility of the ions and only slightly disturbs the mechanical structure of the semi-interpenetrating network, so that in addition to the increased conductivity, a very reproducible charge/discharge process is also obtained. For the calculation of the ratio, the EO units of the crosslinked polymer and the EO units of the un-crosslinked polymer are considered. The respective quantities can thereby be determined via methods known to the person skilled in the art. The ion concentration, for example, can be determined by dissolving the network and ICP. The number of EO units can be determined, if necessary after breaking the covalent bonds of the crosslinked polymer, for example via HPLC or GC methods. Preferably, the ratio can also be from greater than or equal to 8 and less than or equal to 13, further preferably from greater than or equal to 9 and less than or equal to 12.

Further, within a preferred aspect of the solid electrolyte, per an embodiment, the solid electrolyte may have a thickness of greater than or equal to 20 μm and less than or equal to 60 μm. Surprisingly, it has been shown that the solid electrolyte according to an embodiment exhibits excellent mechanical stability even at very low film thicknesses. These layer thicknesses are sufficient to provide a very reproducible electrical behavior over many charge/discharge cycles. Thus, very compact and durable designs can be realized. Overall, layer thicknesses of up to 250 μm, preferably up to 200 μm and further preferably up to 150 μm can be produced.

Within a preferred aspect of the solid electrolyte, per an embodiment, the weight ratio of non-crosslinked polymer PN and crosslinked polymer PV in the sIPN, expressed by the quotient PN/PV, may be greater than or equal to 2 and less than or equal to 2.5. These ratios of the weight of non-crosslinked and crosslinked polymer have been shown to be particularly mechanically stable and lead to preferred amorphous structures, which allow sufficient conductivity of the solid electrolyte even at low temperatures.

In an embodiment of the solid electrolyte, the PEGdMA may have an average molecular weight greater than or equal to 300 g/mol and less than or equal to 1000 g/mol. This range of chain lengths for the crosslinkable polymer have resulted in preferential stability of the obtainable semi-interpenetrating networks. Larger PEGdMA chains can lead to a reduction in mechanical strength. Shorter chains may also reduce mechanical strength, likely due to insufficient crosslinking of the relatively short chains. In a further embodiment, the PEGdMA may have an average molecular weight greater than or equal to 4500 g/mol and less than or equal to 900 g/mol, further greater than or equal to 600 g/mol and less than or equal to 850 g/mol.

In a further embodiment of the solid electrolyte, the solid electrolyte may be a solid electrolyte for a Li solid state battery and the alkali metal conducting salt may be a mixture of at least two different lithium salts. The use of a mixture of different conducting salts can lead to improved electrical properties in the solid electrolytes according to the invention. Suitable combination for a Li structure can be selected, for example, from LiTFSI+LiFTFSI, LiTFSI+LiFSI, LiTFSI+LiBF4, LiTFSI+LiBOB, LiTFSI+LiDFOB, LiDFOB+LiBF4 or suitable combinations among them. Furthermore, the solid electrolyte can contain other additives, such as fluorinated additives, which may suppress aluminum dissolution of other battery components, or SEI additives, which can be used to stabilize the anode boundary layer.

Further according to an embodiment is a process for the solvent-free preparation of an alkali metal battery solid electrolyte comprising a semi-interpenetrating polymer network, said process comprising the steps of:
(a) preparing a homogeneous solution of an alkali conducting salt, a polymerization initiator and a crosslinkable polymer having at least two crosslinkable groups;
b) mixing the solution obtained from step a) with a non-crosslinkable polymer to obtain a homogeneous mixture; and
c) compressing the homogeneous mixture obtained from process step b) to form an uncrosslinked, sheet-like membrane;
d) Crosslinking of the membrane obtained in process step c) to obtain a solid electrolyte.

Surprisingly, it was found that homogeneous solid electrolytes are obtained via solvent-free and purely mechanical preparation, which also exhibit very good mechanical and electrical properties. Without being bound by theory, the mechanical and solvent-free preparation seems to be highly suitable to provide amorphous semi-interpenetrating networks with low crystalline fractions, which has a positive effect on the conductivity and the temperature dependence of the same.

Process step a) comprises the preparation of a homogeneous solution of alkali conducting salt, polymerization initiator and crosslinkable polymer. The homogeneous solution can be formed by purely mechanical mixing or stirring of the three components. The definitions for the possible conducting salts and the crosslinkable polymers have already been given above. Suitable polymerization initiators are chemical substances known to those skilled in the art which are capable of decomposing by means of the change of an environmental variable, for example into radicals, and thus crosslinking the crosslinkable polymer. Possible environmental variables are, for example, temperature or an energy input via irradiation with light of different wave-lengths. Possible initiators are therefore compounds which decompose into radicals either by heat or irradiation. This process step a) is carried out in such a way that the initiator does not yet react.

Process step b) comprises mixing the solution obtained from step a) with a non-crosslinkable polymer. This process step can also be carried out, for example, by purely mechanical mixing or kneading of the mixture. Usual time periods until a homogeneous mixture is obtained can be in the range of 1 h-2 h, for example.

Process step c) comprises pressing of the mixture obtained from process step b). The pressing can be carried out by means of a press, whereby the pressing can be carried out, for example, in a pressure range of 0.1-200 MPa over a time period of 30 min-3 h. Typically, via the pressing process, the mixture can be reduced in thickness by a factor of 10%-100%, preferably 20% 80%. Via this thickness reduction, mechanically very stable but still sufficiently porous networks can be provided after polymerization, which exhibit very good mechanical and electrical properties. Without being bound by theory, this also seems to be attributable to the fact that the networks thus obtained do not exhibit solvent traces. This may contribute to an increase in the reproducibility of the electrical charge/discharge processes.

Process step d) comprises the crosslinking of the membrane obtained in process step c) to obtain a solid electrolyte. Crosslinking of the membrane can be accomplished by changing the environmental conditions that stimulate the initiator to form radicals. For example, the membrane can be exposed to higher temperatures in a heating oven. Optionally, the crosslinked membrane can be dried by further temperature treatment under normal pressure or in a vacuum to remove any traces of water.

In an embodiment of the process, Li-TFSI can be used as the solvent-free alkali metal conducting salt in process step a), azoisobutyronitrile (AIBN) can be used as the polymerization initiator and PEGdMA can be used as the crosslinkable polymer with at least two crosslinkable groups, and PEO can be used in process step b). With these components, the process according to an embodiment can contribute to the production of solid electrolytes for particularly long-life batteries with reproducible charge/discharge kinetics. In addition, the batteries exhibit a wider temperature window in which particularly advantageous electrical properties can be achieved, per certain embodiments. In particular, this temperature window is shifted toward lower temperatures.

Within a further embodiment of the process, the polymerization initiator can be incorporated in process step b) instead of process step a). In addition to incorporation in process step a), the polymerization initiator can also be incorporated into the mixture in process step b). This can counteract an undesired reaction of the initiator in process step a) and shift the temperature window of the processing to higher temperatures.

Further according to an embodiment is a polymeric solid electrolyte which has been produced by the process. For the advantages of the solid electrolyte, explicit reference is made to the advantages of the process as described herein. Without being bound by theory, it appears that via solvent-free production, a modified proportion of amorphous regions is obtainable, which may result in improved conductivity or longer life of batteries equipped with the polymeric solid electrolyte.

Further according to an embodiment is an alkali metal battery comprising an anode, a cathode and a solid electrolyte arranged between anode and cathode, wherein the solid electrolyte is a solid electrolyte. For the advantages of the alkali metal batteries, explicit reference is made to the advantages of the process and the polymeric solid electrolyte. The batteries may generally have other layers in addition to the components mentioned.

Materials for all-solid-state lithium-ion batteries or lithium-metal batteries can be used for the positive electrode of the alkali-metal battery in an embodiment as a Li-metal battery. In this regard, the electrode layer includes active materials such as LiNixMnyCozO2 (NMC), LiCoO2 (LCO), LiFePO4 (LFP) or LNixMnyO4 (LNMO). In addition, the positive electrode may further comprise binder, electronically conductive material to increase electronic conductivity, e.g. acetylene black, carbon black, graphite, carbon fiber and carbon nanotubes, and electrolyte material, in particular a polymer or solid electrolyte, to increase ionic conductivity, as well as other additives.

Materials for an all-solid-state lithium battery may be used as the negative electrode of the alkali metal battery in one embodiment as a Li metal battery. The electrode layer may comprise an active material suitable for a negative electrode, such as a transition metal composite oxide, amorphous carbon, or graphite. In addition, the negative electrode may further comprise binders, for example polyvinylidene fluoride (PVDF), polyethylene glycol (PEG) or alginates in combination with finely divided silicon, as well as electronically conductive material to increase electronic conductivity, and electrolyte material, in particular a polymer or solid electrolyte, to increase ionic conductivity, as well as other additives. Advantageously, however, pure lithium, for example in the form of a Li foil, or alloys of lithium with indium or gold, zinc, magnesium or aluminum can also be used as negative electrodes. Other suitable negative electrodes for all-solid-state lithium-ion batteries include graphite electrodes, silicon-based electrodes, silicon-carbon composites, titanium oxides, and lithium metal electrodes.

In an embodiment of the battery, the battery may be a Li-metal battery and the battery may have at least one high-current or high-voltage electrode. Due to the improved mechanical and electrical properties of the solid electrolyte, the solid electrolytes according to an embodiment are particularly suitable for the above-mentioned electrically highly demanding applications. High-current electrodes are electrodes that can provide a specific capacity of more than 100 mAhg−1 with a charging time of less than or equal to 15 hours. High-voltage electrodes can provide a final charge voltage of ≥4V.

In a further embodiment, the solid electrolyte can be used in electrochemical devices. Electrochemical devices may include fuel cells or capacitors in addition to primary and secondary batteries. Furthermore, the solid electrolyte can be used in electrochemical devices as a layer to improve the electrical contacting (“wetting”) of electrodes.

### BRIEF DESCRIPTION OF THE FIGURES

These and other aspects of the invention will be apparent from and elucidated with reference to the figures and examples described hereinafter, wherein even individual features disclosed in the figures and the examples and in the disclosure as a whole can constitute an aspect of the present invention alone or in combination, wherein additionally, features of different embodiments can be carried over from one embodiment to another embodiment without leaving the scope of the present invention.

In the drawings:

FIG. 1 shows the average capacity and standard deviations of batteries with a pure PEO solid electrolyte;

FIG. 2 shows the average capacity and standard deviations of batteries with a PEO/PEGdMA solid electrolyte (PEGdMA 45 wt.-% based on PEO);

FIG. 3 shows the normalized specific capacitance of a solid electrolyte (PEO/PEGdMA) according to an embodiment and a solid electrolyte (PEO) not according to an embodiment;

FIG. 4 shows the normalized specific capacity of a battery with a solid electrolyte according to an embodiment at 40° C. (triangles) and 60° C. (circles) as a function of the charge/discharge cycles;

FIG. 5 shows a DSC thermogram (temperature range −100° C.-100° C., 10 K/min) on solid electrolytes according to an embodiment (45 wt.-% PEGdMA) with different EO:Li ratios;

FIG. 6 shows the conductivity of solid electrolytes (45 wt.-% PEGdMA) according to an embodiment as a function of EO:Li ratio and as a function of temperature;

FIG. 7 shows the voltage behavior of a battery with solid electrolytes according to an embodiment (45 wt.-% PEGdMA) over time as a function of the number of different Li conducting salts in an arrangement of NMC622//PEO+PEGdMA//Li at 60° C. with a specific charging current of 15 mA g 1;

FIGS. 8 and 9 show the battery voltage using different anodes as a function of time;

FIGS. 10 and 11 show the electrical properties of batteries with an sIPN of polycaprolactone and PEGdMA (45 wt.-% based on PCL) in an arrangement of NMC622//Polycaprolactone+PEGdMA//Li at 60° C.

### DETAILED DESCRIPTION

### Examples

I. Preparation of the Solid Electrolytes

I.a. Solvent Process Using the Example of a Li Solid Electrolyte (State of the Art)

Lithium bis(trifluoromethanesulfonyl)imide (LiTFSI, 0, 878 g) is dissolved in acetonitrile (6 g) together with PEGdMA (0.450 g) and the radical initiator azoisobutyronitrile (AIBN, 0.047 g, 2 wt.-%). The solution is added to a vessel containing polyethylene oxide (PEO, 1 g, 300 kg/mol) and stirred for four hours at room temperature. The mixture is applied to a Mylar plastic film using a doctor blade method. The membrane is dried in a fume hood for at least half an hour. The film is polymerized at 80° C. under nitrogen flow for 1 hour and then dried in vacuum for at least 12 hours. A wet film thickness of about 1.5 mm is required to produce a polymer layer about 150 μm thick.

I.b. Solvent-Free Process Using the Example of a Li Solid Electrolyte—Variant A

The conducting salt LiTFSI (0.878 g) is stirred together with PEGdMA (0.450 g) and the radical initiator AIBN (0.047 g, 2 wt %) for 1 hour until a clear solution is formed. The solution is spread onto the PEO powder (1 g, 300 kg/mol) and mixed using a magnetic stirrer at 1000 rpm for 10 min. The components clump together. The mixture is placed between two Mylar films with a 100 μm spacer and repeatedly pressed and folded using a laboratory press with a force of 25 kN for half an hour. The mixture is finally pressed to the desired film thickness and polymerized between Mylar films at 80° C. under nitrogen flow for 1 hour. Optionally, the membrane can then be dried in a vacuum for 12 hours.

I.c. Solvent-Free Process Using the Example of a Li Solid Electrolyte—Variant B

The conducting salt LiTFSI (0.878 g) is added to a mortar together with PEO powder (1 g, 300 kg/mol) and homogenized for 10 min. The resulting gum-like material is sealed in a pouch bag film and stored at 60° C. for two days. A solution of PEGdMA (0.450 g) and the radical initiator AIBN (0.047 g, 2 wt.-%) is prepared with stirring for 1 hour. The solution is vacuum sealed in a pouch bag together with the previously prepared PEO-LiTFSI material and stored for 24 hours.

The mixture is placed between two Mylar films with a 100 μm spacer and repeatedly pressed and folded using a laboratory press for half an hour. The mixture is finally pressed to the desired film thickness and polymerized between Mylar films at 80° C. under nitrogen flow for 1 hour. Optionally, the membrane can then be dried in a vacuum for 12 hours.

I.d. Solvent-Free Process Using the Example of a Li Solid Electrolyte—Variant C

The conducting salt LiTFSI (0.878 g) is given into a mortar together with PEO powder (1 g, 300 kg/mol) and homogenized for 10 min. A solution of PEGdMA (0.450 g) and the radical initiator AIBN (0.047 g, 2 wt %) is prepared with stirring for 1 hour. The solution is also placed in the mortar and homogenized for at least 10 min. The mixture is placed between two Mylar films with a 100 μm spacer and repeatedly pressed and folded using a laboratory press for half an hour. The mixture is finally pressed to the desired film thickness and polymerized between Mylar films at 80° C. under nitrogen flow for 1 hour.

II. Structure of a Battery Cell

Unless explicitly stated otherwise, the measurements on battery types according to an embodiment were carried out on solid electrolytes produced by a solvent process. The electrical properties of solid electrolytes according to an embodiment, which were produced by a solvent-free process, may have higher amorphous contents. For use in lithium metal battery cells, a round piece of polymer film with a layer thickness of 100 μm is punched out and inserted between a lithium metal electrode and a positive electrode in a manner analogous to a separator. The electrical properties of lithium metal battery cells produced in this way were tested at different temperatures (60° C., 40° C.).

III. Electrical Properties

IIIa. Specific Capacity as a Function of Charge/Discharge Cycles

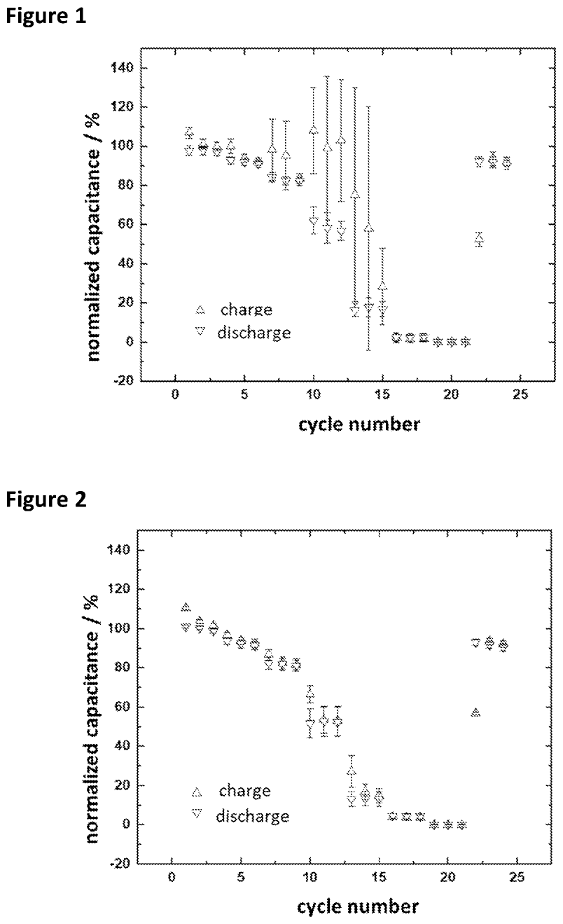

FIGS. 1 and 2 show the normalized specific capacity of lithium metal battery cells according to an embodiment and those not according to an embodiment as a function of charge/discharge cycles. The normalization is performed to a theoretical capacity of 176 mAh/g. The battery construction is as follows: positive electrode: NMC622; negative electrode: Li; charge current (3× each): 7.5 mA g−1, 15 mA g−1, 30 mA g−1, 75 mA g−1, 150 mA g, 300 mA g−1, 750 mA g−1, 7.5 mA g−1-1, voltage range 3.0-4.3 V, solid electrolyte as specified with an EO:Li ratio of 15:1; temperature 60° C.

FIG. 1 shows the average capacity and standard deviations of batteries with a pure PEO solid electrolyte and FIG. 2 the average capacity and standard deviations of batteries with a PEO/PEGdMA solid electrolyte (PEGdMA 45 wt.-% based on PEO). In each case, the mean values and standard deviation of measurements on 5 different battery cells are shown. It is clear from a comparison of FIGS. 1 and 2 that the standard deviations for the specific capacity of the batteries according to an embodiment are significantly smaller compared to the batteries with pure PEO solid electrolyte. This suggests a more reproducible charge/discharge process of the batteries according to an embodiment. It is likely that the calation/intercalation processes of the metal ions disturb the mechanical structure of the solid electrolytes of an embodiment less than the structure of pure PEO solid electrolytes. Without being bound by theory, the increased electrical stability of the solid electrolytes of an embodiment can be attributed to reduced dendrite growth during charge/discharge processes in the mechanically stabilized solid electrolytes of the invention.

IIIb. Galvanostatic Charging/Discharging

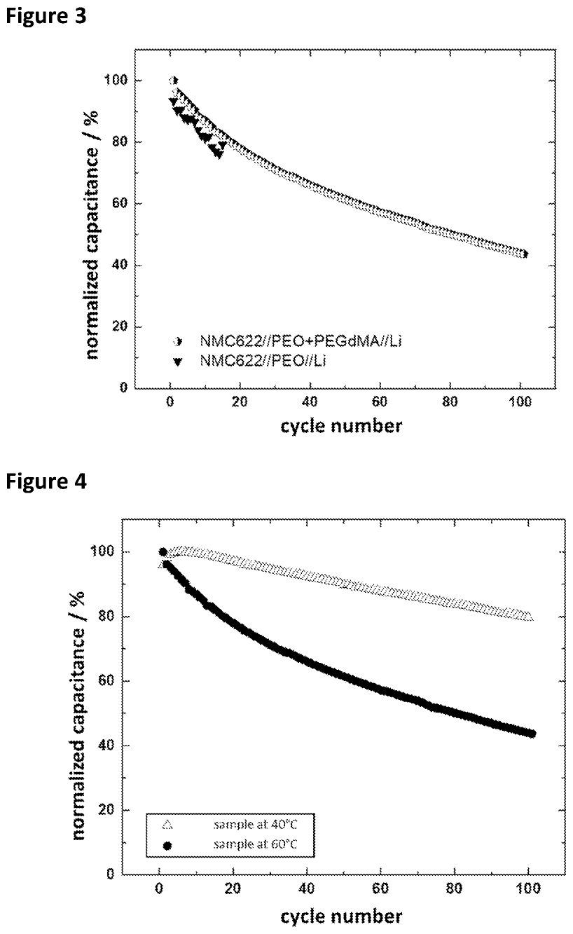

FIG. 3 shows the normalized specific capacitance of a solid electrolyte (PEO/PEGdMA) according to an embodiment and a solid electrolyte (PEO) not according to an embodiment. The specifications of the experimental setup are as follows: Cell type: 2032 button cell, Electrode: NMC 622 (Targray) Li (Albemarle); Electrolytes as indicated; EO:Li ratio: 15:1; Test procedure: 1× C/20, 100× C/10; Voltage range: 3.0-4.3 V; Temperature: 60° C.; Active mass=4 mg.

A comparison of the data for solid electrolytes according to an embodiment and those not according to an embodiment shows that the solid electrolytes according to an embodiment have a significantly increased service life compared with the pure PEO solid electrolytes. In particular, the charge/discharge characteristics as well as the reproducibility are improved by using the solid electrolytes according to an embodiment.

IIIc. Temperature Dependence of the Normalized Specific Capacitance as a Function of the Charge/Discharge Cycles

The FIG. 4 shows the normalized specific capacity of a battery with a solid electrolyte according to an embodiment at 40° C. (triangles) and 60° C. (circles) as a function of the charge/discharge cycles. It can be seen from the curve of the specific capacitance that the solid electrolyte according to an embodiment has very good stability, especially at low temperatures, and that the capacitance decreases only to a very small extent.

IIId. Amorphous Phase

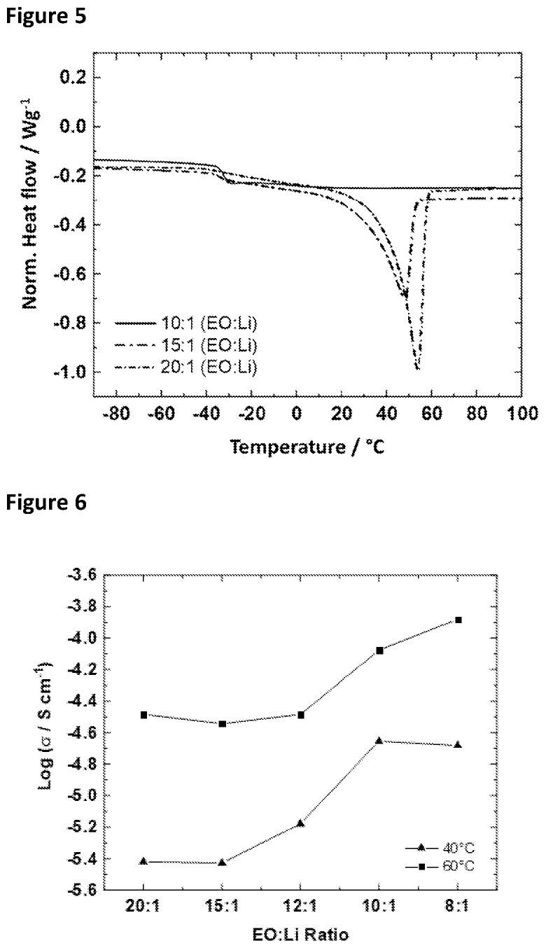

The FIG. 5 shows a DSC thermogram (temperature range −100° C.-100° C., 10 K/min) on solid electrolytes according to an embodiment (45 wt.-% PEGdMA) with different EO:Li ratios. By increasing the Li salt concentration to 10:1 in the solid electrolyte, the crystalline portion on the solid electrolyte can be suppressed. Accordingly, a highly amorphous solid electrolyte with improved electrical properties is obtained.

IIIe. Conductivity

The FIG. 6 shows the conductivity of solid electrolytes (45 wt.-% PEGdMA) according to an embodiment as a function of EO:Li ratio and as a function of temperature. The apparatus setup is as follows: EIS; frequency range: 1 MHz-1 Hz; temperature range 0° C.-70° C.; cell: button cell 2032; sample height: 100 μm; sample diameter: 15 mm (circle); blocking electrodes: stainless steel.

It can be seen from the FIG. 6 that the batteries according to an embodiment with the solid electrolytes according to an embodiment have at 40° C. and an EO:Li ratio of 1:10 an ionic conductivity comparable to 60° C. Thus, the low-temperature behavior of the solid electrolytes according to an embodiment is significantly better than the electrical behavior of pure PEO solid electrolytes.

IIIf. Use of Two Different Li Conducting Salts

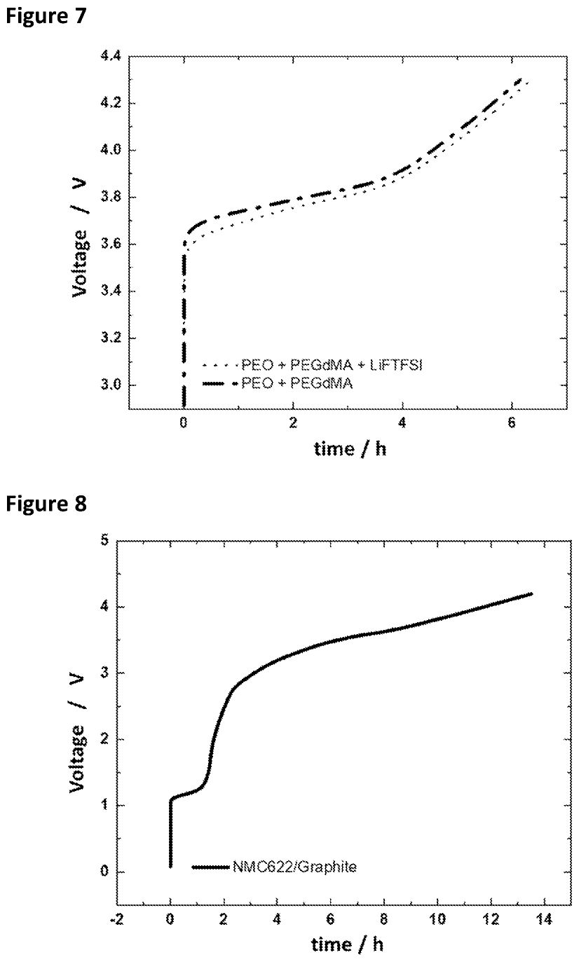

The FIG. 7 shows the voltage behavior of a battery with solid electrolytes according to an embodiment (45 wt.-% PEGdMA) over time as a function of the number of different Li conducting salts in an arrangement of NMC622//PEO+PEGdMA//Li at 60° C. with a specific charging current of 15 mA g 1. The figure shows that the use of two Li salts (LiTFSI with LiFTFSI) results in an improved voltage rise over time compared with solid electrolytes with only one conducting salt. It can be seen from the figure that the use of two Li salts (LiTFSI with LiFTFSI) results in an improved voltage rise over time compared to solid electrolytes with only one conducting salt (LiTFSI).

IIIg. Electrodes

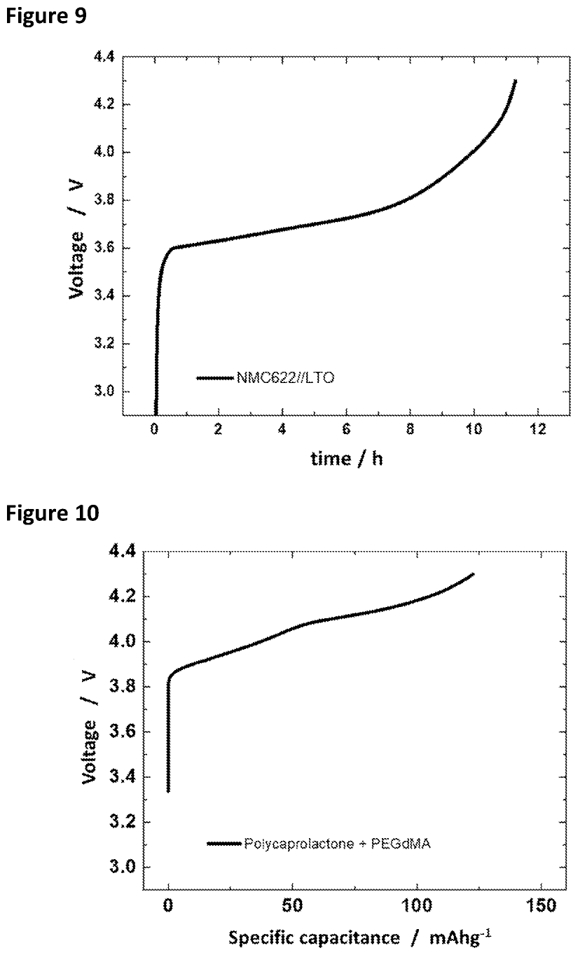

The FIGS. 8 and 9 show the battery voltage using different anodes as a function of time. In the FIG. 8, an arrangement of NMC622//PEO+PEGdMA//Graphite was used, and in the FIG. 9, an arrangement of NMC622//PEO+PEGdMA//LTO was used. It can be seen from the orders that faultless operation of cells using NMC622 and a negative electrode different from metallic lithium is possible.

IIIh. sIPN with Polycaprolactone

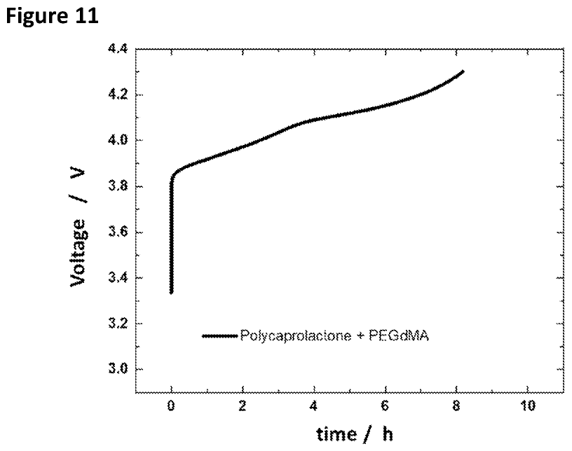

FIGS. 10 and 11 show the electrical properties of batteries with an sIPN of polycaprolactone and PEGdMA (45 wt.-% based on PCL) in an arrangement of NMC622//Polycaprolactone+PEGdMA//Li at 60° C. The FIG. 10 shows the voltage as a function of specific capacitance, and FIG. 11 shows the voltage curve as a function of time at a specific charging current of 15 mA g 1.

It can be seen from the figures that even with PCL as a component of the sIPN, stable and electrically suitable solid electrolytes are obtained, which are suitable for use in batteries.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. Solid electrolyte for an alkali metal solid state battery,
wherein
the solid electrolyte comprises at least one alkali metal conducting salt and a semi-interpenetrating network (sIPN) of a crosslinked and a non-crosslinked polymer, wherein the semi-interpenetrating network comprises
greater than or equal to 50% by weight and less than or equal to 80% by weight of a non-crosslinked polymer selected from the group consisting of polyethylene oxide (PEO), polycarbonate (PC), polycaprolactone (PCL), chain end modified derivatives of these polymers or mixtures of at least two components thereof; and
greater than or equal to 20% by weight and less than or equal to 50% by weight of polyethylene glycol dimethacrylate (PEGdMA) as crosslinked polymer, wherein the solid electrolyte consists of greater than or equal to 90% by weight and less than or equal to 100% by weight of the alkali conducting salt and the sIPN, and the solid electrolyte is solvent-free.

2. The solid electrolyte of claim 1, wherein the non-crosslinked polymer is polyethylene oxide and the solid electrolyte has a molar ratio of ethylene oxide units to alkali ions, expressed by the quotient EO/Li, of greater than or equal to 5 and less than or equal to 15.

3. The solid electrolyte of claim 1, wherein the solid electrolyte has a thickness of greater than or equal to 20 μm and less than or equal to 60 μm.

4. The solid electrolyte of claim 1, wherein the PEGdMA has an average molecular weight greater than or equal to 300 g/mol and less than or equal to 1000 g/mol.

5. The solid electrolyte of claim 1, wherein the solid electrolyte is a solid electrolyte for a Li solid battery and the alkali metal conducting salt is a mixture of at least two different lithium salts.

6. A process for the solvent-free preparation of an alkali metal battery solid electrolyte comprising a semi-interpenetrating polymer network comprising the process steps:
a) preparing a homogeneous solution of an alkali conducting salt, a polymerization initiator and polyethylene glycol dimethacrylate (PEGdMA) as a crosslinkable polymer having at least two crosslinkable groups;
b) mixing the solution obtained from step a) with a non-crosslinkable polymer selected from the group consisting of polyethylene oxide (PEO), polycarbonate (PC), polycaprolactone (PCL), chain end modified derivatives of these polymers or mixtures of at least two components thereof, to obtain a homogeneous mixture; and
c) compressing the homogeneous mixture obtained from process step b) to form an uncrosslinked, sheet-like membrane;
d) Crosslinking of the membrane obtained in process step c) to obtain a solid electrolyte,
wherein the semi-interpenetrating network obtained comprises greater than or equal to 50% by weight and less than or equal to 80% by weight of the non-crosslinked polymer and comprises greater than or equal to 20% by weight and less than or equal to 50% by weight of polyethylene glycol dimethacrylate (PEGdMA) as the crosslinked polymer, wherein the solid electrolyte consists of greater than or equal to 90% by weight and less than or equal to 100% by weight of the alkali conducting salt and the sIPN, and the solid electrolyte is solvent-free.

7. The process according to claim 6, wherein in process step a) Li-TFSI is used as solvent-free alkali metal conducting salt, azoisobutyronitrile (AIBN) is used as polymerization initiator, PEGdMA is used as crosslinkable polymer having at least two crosslinkable groups, and PEO is used in process step b).

8. The process according to claim 6, wherein the polymerization initiator is incorporated in process step b) instead of process step a).

9. Alkali metal battery comprising an anode, a cathode and a solid electrolyte arranged between anode and cathode, wherein the solid electrolyte is a solvent-free solid electrolyte according to claim 1.

10. The battery of claim 9, wherein the battery is a Li metal battery and the battery includes at least one high current or high voltage electrode.
